(19) United States
(12) Patent Application Publication
(10) Pub. No.: US 2004/0065759 A1
(43) Pub. Date: Apr. 8, 2004

(54) Monofilament fishing line grinder/disposer

(76) Inventor: Raymond Macco, Aberdeen, NJ (US)

Correspondence Address: RAYMOND MACCO, 19 WISTER PLACE, ABERDEEN, NJ, 07747, US

(21) Appl. No.: 10/265,483

(22) Filed: Oct. 7, 2002

(51) Int. Cl. B02C 19/12

(52) U.S. Cl. 241/37.5; 241/100

(57) ABSTRACT

In accordance with the present invention, a small portable grinding machine enabling the fishing person(s) to act in a responsible manor when disposing of unwanted and extra monofilament fishing lines. This provides the allowance for a more proper disposal of said monofilament line thereby causing a reduction in the ecological ramifications of entanglement to fish and wildlife. The said invention can help reduce the plastic issued associated with the pollution of said waterways in helping to keep the oceans, lakes, rivers, and ponds free of this material. The machine would also reduce the risks associated with safety issues in reducing the amounts of monofilament fishing line that can become entangled on boat propellers, boat intake ports, and the like, causing delays, engine problems, and the associated safety issues.

### BACKGROUND

This invention relates to the problems that are currently inherent and are directly related to the impacts of marine debris. These marine debris impacts are primarily separated into biological impacts and economical impacts.

### Biological Impacts

Biological impacts relate to marine and littoral animals, plants and entire ecosystems. Entanglement and ingestion maim and kill wildlife in our waterways. Other biological impacts include the carrying and transmission of many epiphytic species to distant shores, spreading infection and disease.

Entanglement is the most obvious of biological impacts. It is known that over 135 different species of marine vertebrates and approximately 8 invertebrates have been reported to have encountered some form of entanglement. Monofilament fishing line is often (reportedly 49.5%) the object that causes this problem.

Ingestion is less obvious in that wildlife very often mistakes these debris for food. It is known that over 160 different species of vertebrates (including nearly 100 percent of some bird species) and 2 invertebrate species have been reported to ingest these debris.

Evidence of disease transmission has been proven, however the true scope and extent of the problem is still unknown at this time.

### Economic Impacts

Economic impacts relate to the reduction of opportunities to exploit the marine environment, for pleasure or profit. The appearance of pollution and hazardous materials reduce the value of human activity. Beachgoers, boaters, and recreational anglers are reduced as debris ruin the aesthetic value of their sport.

In short, marine debris reduce the wildlife population of ocean birds, fish, turtles, seals, and whales.

### A Recommendation

Research organizations recommend the development and implementation of mechanisms to reduce fishing gear loss.

### Information Source Sponsors

Intergovernmental Oceanographic Commission

U.S. National Oceanic and Atmospheric Administration

U.S. Environmental Protection Agency

U.S. Navy

U.S. Coast Guard

U.S. Marine Mammal Commission

Center for Marine Conservation

Society of the Plastics Industry

### SUMMARY OF THE INVENTION

In view of the forgoing disadvantages inherent regarding the known problems of ecology and safety, the present invention provides an alternate solution in reducing the amounts of pollutant plastic material in our waterways. As such, the general purpose of the present invention, which will be described subsequently in greater detail, is to provide an easier way for the recreational fisherman as well as the commercial fishing industry to dispose of scrap monofilament fishing line. By providing an easier, more convenient way of processing this scrap material, the industry will be more apt to comply with any current laws and any future laws that may be in existence or proposed. In addition to complying with any said present or future regulations, the reason for the invention is to allow humankind to voluntarily and actively participate in the improvement of any such ecological issues.

### DESCRIPTION OF DRAWINGS

The present invention may be better understood by reference to the written specification in conjunction with the drawings, wherein:

FIG. 1A is a detailed drawing showing the first cutting blade of the invention.

FIG. 1B is a detailed drawing showing the second cutting blade of the invention.

FIG. 2 is an exploded, perspective view showing the general arrangement and components of the invention.

FIG. 3 is an electronic schematic diagram of the invention.

### DESCRIPTION

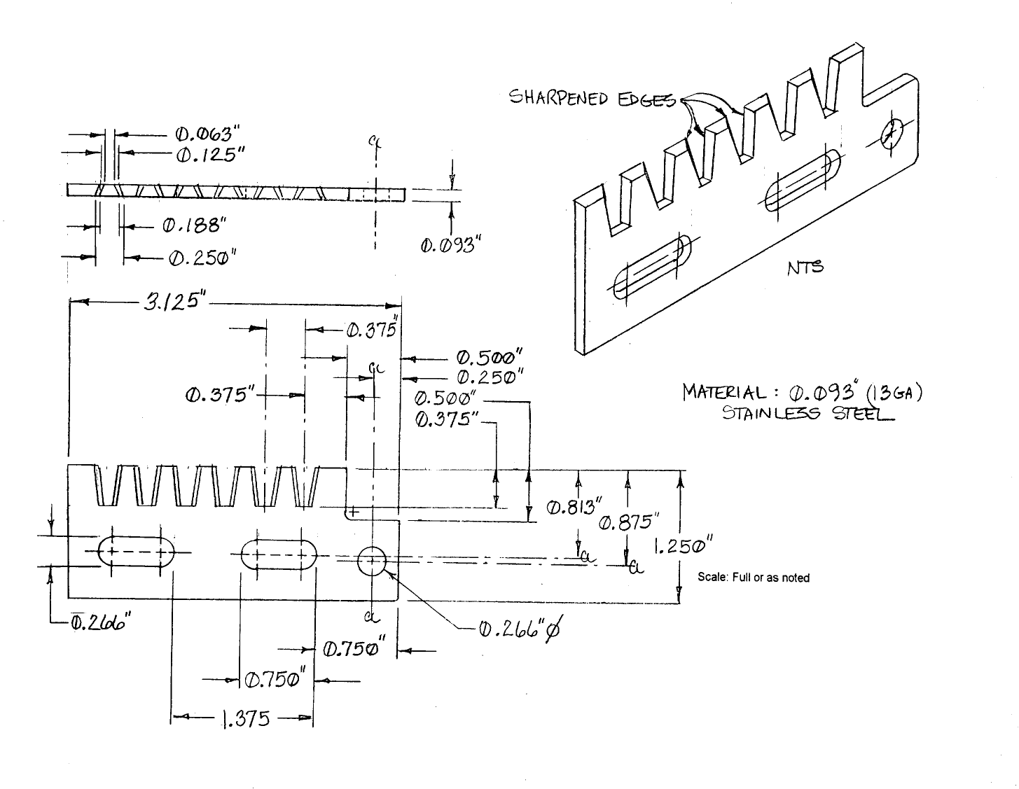

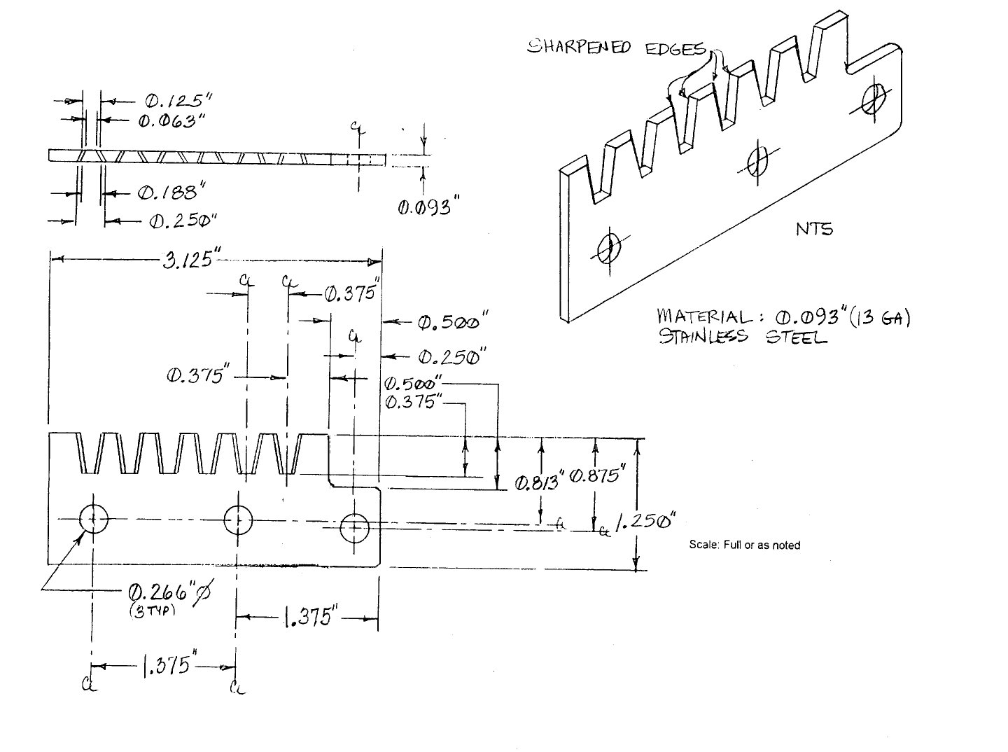

With reference now to the drawings, and in particular to FIG. 1A thereof, a newly designed reciprocating blade (blade #1) which slides along side of stationary blade (blade # 2) as shown in FIG. 1B which during a given cutting cycle causes gaps to be created and then closed between blades, exposing the blades cutting surfaces to the monofilament material. These blades are to be manufactured of 13 gauge (0/093″ thick) stainless steel.

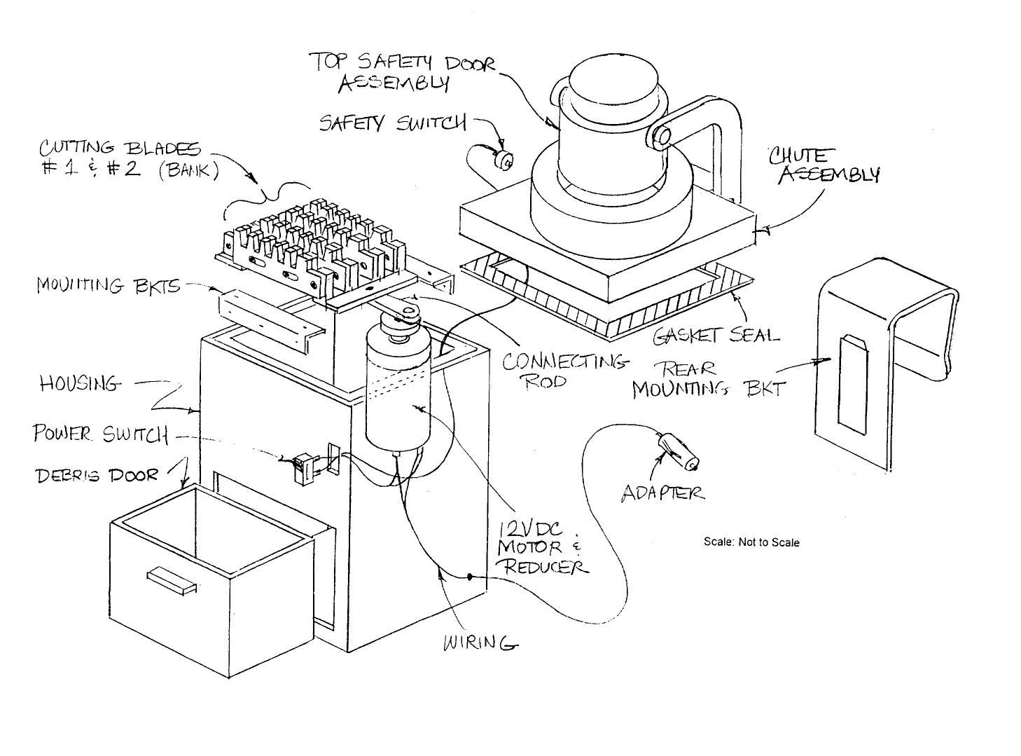

A 12 volt direct current motor is used, as shown in FIG. 2, and connected to a gear reducer which reduces the revolutions per minute of the output shaft of the motor while in turn building rotational force on the output shaft of the gear reducer. This output shaft rotates at a slower rate but with a higher torque and force.

As shown in FIG. 2, the output shaft of the gear reducer is then connected to a connecting rod, of which transfers the rotational motion into a linear motion. It is this linear motion under the force that is generated by the gear reducer and motor combination that is transferred to a bank of these blades in FIG. 1 and FIG. 2.

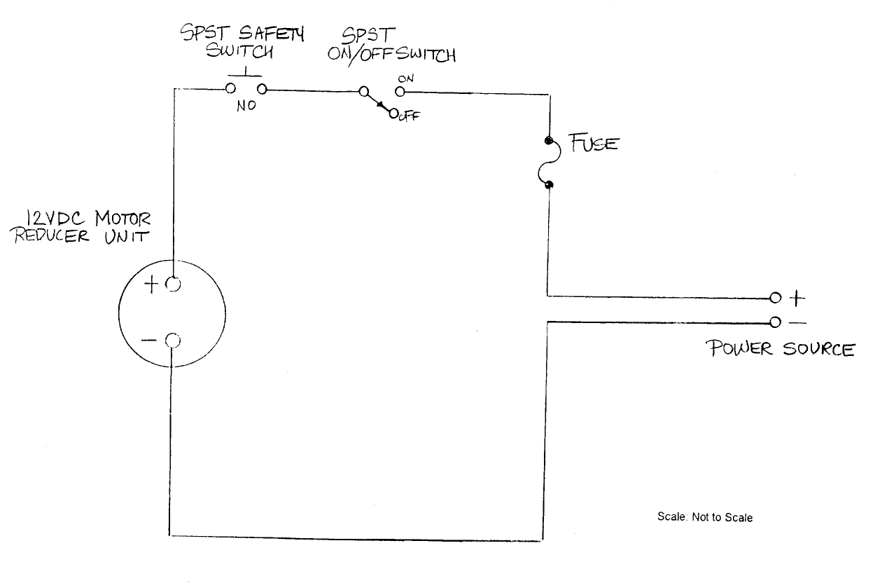

The electrical system and shown on the schematic diagram in the drawing in FIG. 3, is comprised of a 12 volt direct current adapter plug that is capable of being inserted into a cigarette lighter on a given vessel, an electrical cable connecting the adapter to the machine, an on-off power switch, an electrical fusible link, and a chute safety switch.

The housing, as shown in FIG. 2 is and injection molded container, molded of a high impact polystyrene material. It contains a removable door that can be opened to clean out collected debris of fishing line. The housing also contains a storage compartment behind the door that holds the debris until cleaning is needed. Additionally, the housing contains a chute for loading debris to be severed with a safety door that will not allow the motor to be energized until it is closed completely.

The motor is fastened into the housing with screws that thread into the housing bosses. The blades of the machine are attached in the same fashion. All components of the machine are mounted into the housing. The machine contains an adjustable bracket so that it can be mounted in a variety on applications on board vessels or on docks, counters, walls, and the like.

More specifically, the operation of the machine is as described in the following description. A piece of scrap line is found and in need of disposal. The top safety door is opened and the material is then inserted into the chute. The door is then manually closed, closing the contacts on the safety switch. With the door closed, the power switch is the moved to the “ON” position, energizing the motor. In the event the chute door is opened, the circuit to the motor is opened and the motor is immediately shut off. This creates the safety feature of the invention.

As the motor is energized and turns, the rotational force from the output shaft is then transmitted into the gear reduce component. The gear reducer changes higher revolutions and lower force into lower revolutions and higher force at the output shaft of the reducer. The output shaft of the reducer is then connected to a connecting linkage which changes the rotational motion at the gear reducer into linear motion. This linear motion is then transferred to one set of oscillating blades, blade number one as shown in FIG. 1A.

As the moving blades slide along side of the stationary blades, gaps are created allowing the fishing line to fall in to them. As the cycle continues the gaps close and the line is severed. As the cycle repeats, the gaps open again allowing any cut material to be discharged and new material to enter the cutting area. The discharged material falls between the blade pair gaps and is directed down a chute into a holding compartment.

The holding compartment stores cut material until at which it is full and needs to be emptied. The holding compartment is emptied by opening the lower door and sliding the compartment out.

Therefore, the forgoing is considered as illustrative only of the principles of the invention. Further, since numerous modifications and changes will readily occur to accommodate the necessary manufacturing processes, it is not desired to limit the invention to the exact construction and operation shown and described, and accordingly, all suitable modifications and equivalents may be resorted to, falling within the scope of the invention.

What is claimed as being new and desired to be protected by Letters Patent of the U.S. is as follows:

1. A new device for the processing of scrap and extra unwanted monofilament fishing line by severing amounts of line into small pieces and entrapping them in a container to be properly disposed of at at a later time.

2. A new battery powered, portable device as in claim 1, capable of producing enough force to sever monofilament fishing line of a variety of guages and thusly reducing the dangers to marine wildlife in our waterways.

3. A new device as in claim 1, that can be available in a variety of sizes to accommodate the needs of the small recreational fisherman or the larger commercial fishing vessels as required. The device of said system components comprising of:
a. A 12 volt dc plug-in adapter cord;
b. A set pair of osillating, tapered, multi tooth, stainless steel blades;
c. An injection molded, sealed housing to safely contain all componentry;
d. A removable, emptyable, debris collection bin;
e. A fused circuit for use in wet locations and with wet debris;
f. A 12 volt dc motor and reducer;
g. A safety power cut-off switch while the machine is being loaded;
h. A bracket for mounting
